(19) United States
(12) Patent Application Publication
(10) Pub. No.: US 2026/0022787 A1
(43) Pub. Date: Jan. 22, 2026

(54) THREADED COUPLING WITH GAS TIGHT SEALS AND INTERLOCKING DOVETAIL THREADS

(71) Applicant: PRECISION COUPLINGS, LLC, Houston, TX (US)

(72) Inventors: Michael Keith NATIONS, Jr., College Station, TX (US); Halit Hussein DILBER, Katy, TX (US)

(21) Appl. No.: 19/273,870

(22) Filed: Jul. 18, 2025

Related U.S. Application Data
(60) Provisional application No. 63/674,092, filed on Jul. 22, 2024.

(51) Int. Cl. F16L 15/06; F16L 15/04

(52) U.S. Cl. CPC F16L 15/06; F16L 15/04

(57) ABSTRACT

A threaded coupling for tubulars includes a box member having box threads, a frustoconical seal surface, and a relief groove disposed between the box threads and the frustoconical seal surface. A pin member of the coupling includes pin threads shaped to mate with the box threads to form a threaded connection region and limit axial advancement of the pin member within the box member to a connected position. The connected position disposes a leading portion of the pin threads in the relief groove of the box member and a curvilinear seal surface of the pin member in interference sealing contact with the frustoconical seal surface of the box member.

### CROSS-REFERENCE TO RELATED APPLICATIONS

This application is a nonprovisional application which claims priority from U.S. provisional application No. 63/674,092, filed Jul. 22, 2024, which is incorporated by reference herein in its entirety.

### TECHNICAL FIELD/FIELD OF THE DISCLOSURE

The present disclosure relates generally to tubular threaded couplings with a sealing interface.

### BACKGROUND OF THE DISCLOSURE

Threaded tubular connections join flow conduits in an end-to-end relationship to form a continuous flow path for transporting fluid under pressure. Oilfield tubular goods use such threaded connections for connecting adjacent sections of conduit or pipe, which may be used in various applications including drilling, fracking and production. The threaded connection may define tapered threads in mating pin and box tubular ends that may include sealing regions, such as mating metal-to-metal frustoconical surfaces between the inside of the box and outside of the pin. However, the prior threaded connections can provide unreliable sealing due to galling of the seal from excess radial interference and can have limited reusability because of damage to threads adjacent to the seal where radial stresses act to disengage the threads.

### SUMMARY

For some embodiments, a coupling having a box member with an interior surface that includes box threads, a frustoconical seal surface, and a relief groove disposed between the box threads and the frustoconical seal surface. The coupling further includes a pin member having a mating shape to be inserted into the box member. An outer surface of the pin member includes pin threads shaped to mate with the box threads to form a threaded connection region and limit axial advancement of the pin member within the box member to a connected position, which connected position disposes a leading portion of the pin threads in the relief groove of the box member such that the leading portion of the pin threads thereby lack contact with the box member. A curvilinear seal surface on the outer surface of the pin member shares a same longitudinal central axis with the frustoconical seal surface of the box member such that a seal forms at an interface between the curvilinear seal surface and the frustoconical seal surface in the connected position.

In some embodiments, a coupling includes a box member with an interior surface having box threads in a wedge thread shape that taper between 0.08 inch/inch and 0.1 inch/inch, a frustoconical seal surface with taper between 0.09 inch/inch and 0.142 inch/inch, and a relief groove disposed between the box threads and the frustoconical seal surface. The relief groove defines an inner diameter of the box member greater than at roots of the box threads adjacent the relief groove. In addition, the coupling includes a pin member having a mating shape to be inserted into the box member. An outer surface of the pin member includes pin threads with taper between 0.08 inch/inch and 0.1 inch/inch and shaped to mate with the box threads to form a threaded connection region and limit axial advancement of the pin member within the box member to a connected position, which connected position disposes a leading portion of the pin threads in the relief groove of the box member such that the leading portion of the pin threads thereby lack contact with the box member. The pin threads extend along the pin member a length of 4.0 to 4.25 inches, have a height of 0.07 to 0.072 inches and provide difference between the load flank lead and stab flank lead that is 0.1 inches. A curvilinear seal surface of the outer surface of the pin member shares a same longitudinal central axis with the frustoconical seal surface of the box member such that a seal forms at an interface between the curvilinear seal surface and the frustoconical seal surface in the connected position. A separation area lacks the pin threads and is disposed between the pin threads and the curvilinear seal surface such that contact in the connected position of the frustoconical seal surface with the curvilinear seal surface is separated along length of the pin member more than 0.4 and less than 0.6 inches from the pin threads.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a quarter sectional view of a pin member being inserted into a box member, in accordance with an embodiment of the invention.

FIG. 2 is a sectional view showing part of the pin and box members in a connected position with a leading portion of a pin thread disposed in a relief groove of the box member, for one embodiment of the invention.

FIG. 3 is view of the pin member of a tubular and the box member shown as a dual box end coupler, pursuant to one embodiment of the invention.

FIG. 4 is a sectional view of mated threads of a coupling with box crest to pin root separation, according to some embodiments of the invention.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

As used herein, the term “box member” can refer to a female threaded portion of a threaded connection region which can be made up of internal threads in a helical configuration. The box member can engage a pin member. The box member can be formed on a pipe or another piece of steel that is round and has a conduit therein, such as a tubular. The box member can be a separate piece of a pipe joint.

As used herein, the term “pin member” can refer to a male threaded portion of a threaded connection region which can be made up of external threads in a helical configuration. The pin member can engage a box member. The pin member can be formed on a pipe or another piece of steel that is round and has a conduit therein, such as a tubular. The pin member, in embodiments, can be a separate piece of a pipe joint.

The term “thread form” refers to the configuration of the thread in an axial plane; or more simply, the profile of the thread, composed of the crest, root, flanks and corner radii. At the top of the threads are the crests, at the bottom the roots, and joining them are the flanks. The surfaces are understood to be helically extending along the threaded member.

The term “thread crest” as used herein can refer to an apex of the thread form of the invention, such as a buttress thread form. The apex or crest, for example, for a buttress thread form, can be trapezoidal in shape, such as square or rectangular.

The term “thread root” as used herein can refer to a valley portion of the thread form of the invention, which can be a buttress thread form. The valley portion of the thread form can be trapezoidal in shape, such as square or rectangular.

The term “load flank” as used herein can refer to a portion of the thread on the box member or pin member that can conjoin and transfer an axial tension after the box member conjoins the pin member. The load flank can be a surface of the thread tooth opposite the stab flank.

The term “stab flank” as used herein can refer to a surface of the thread tooth that interfaces when the box and pin members are first brought into contact. The stab flank restricts the axial movement of the threaded connection region when rotating into the fully mated position. The stab flank can provide axial compressive load resistance as the pipes are engaged.

The term “thread height” as used herein can refer to the height from root to crest of the thread form. Wedge threads are tapered threads whose crest and roots are on the same place as the tubular axis and the thread height is composed of the stab flank height from root to crest and the load flank height from root to crest. Due to the taper and axis, the repeated thread form in profile has roots and crests resembling stair steps. The thread height therefore is either averaged or measured by a device with a built-in step compensator. In contrast, many thread forms such as the API buttress have tapered crests and roots and a single thread height.

The term “box thread” as used herein can refer to an internal thread of a box member. The box thread can have a load flank, a stab flank, a root and a crest. A box thread can be a screw threaded fastener for joining with male threads.

The term “box thread tooth” as used herein can refer to a portion of the box member which can remain after a groove has been cut in material forming the box member, such as by a threading tool. The “box thread tooth” can have three sides, a stab flank, a crest and a load flank. The repeating thread form is commonly called teeth because of the profile shape of the box member resembling teeth.

The term “flank angle” as used herein can refer to an angle of either a stab flank or a load flank. The flank angle can refer to an acute angle in a plane coinciding with a longitudinal pipe axis. The flank angle can be measured between the flank of a box member and a plane or a flank of a pin member and a plane, wherein the plane can be positioned 90 degrees to the longitudinal pipe axis. The flank angle can be positive or “a plus number” if the flank faces toward the crest. The flank angle can be minus or “a negative number” if the flank faces toward the root.

The term “pin root” as used herein can refer to a valley portion of a thread form of the invention. The valley for the thread form can be trapezoidal in shape, such as, square or rectangular. The pin root can be adjacent to the pin thread tooth.

The term “pin stab flank” as used herein can refer to a surface of the pin thread tooth that can meet a box member stab flank to restrict the axial movement of the threaded connection region prior to threading pipes into connection. The pin stab flank can provide compressive load resistance once the threads of the connections, which can be pipes in an embodiment, are engaged.

The term “pin thread” as used herein can refer to an external thread of a pin member. The pin thread can have a load flank, a stab flank, a root and a crest. A pin thread is commonly referred to as a male member that joins to a female thread, usually in a threaded configuration.

The term “pin thread tooth” as used herein can refer to a portion of the pin member which can remain after a groove has been cut in material forming the pin, such as by a threading tool. The “pin thread tooth” can have three sides, a stab flank, a pin crest and a load flank. The repeating thread form is commonly called teeth because of the profile shape of the pin member resembling teeth.

The term “frustoconical” describes the shape of a frustum of a cone, like a funnel that is wide at the top and narrow at the bottom. In geometry, the frustum is the portion of the cone that lies between one or two parallel planes cutting the cone. A right frustum is a parallel truncation of a right pyramid or right cone. Frustoconical may be used to describe seal or thread form geometry.

The term “taper” or “tapered thread” or “tapered seal” is conical in contrast to the parallel sided cylindrical section commonly found on bolts and leadscrews. As the pin and box members are assembled the cone allows the screw threads to have a larger contact surface which stabilizes and funnels the forces toward the central axis of the pipe. Bolts, in contrast, are straight threads and care must be taken when aligning and screwing the nut on to avoid seizing or cross threading.

Screwing two tapered conical screw threads is self-aligning. Taper has units of inches per inch (inch/inch). Taper is a ratio of the change of the diameter at the base of the cone over one inch along the cone's axis. Taper can also be expressed as a ratio or an angle with respect to the cone's center axis.

The term “lead” is the linear distance the screw travels in one revolution.

The term “pitch” is the distance measured parallel to the thread axis, between corresponding points on adjacent threads. Unified screw threads are designated in threads per inch. This is the number of complete threads occurring in one inch of threaded length. Pitch and lead are mathematically related in that pitch=1 inch/lead in inches. Example: lead=0.200 inch then pitch=1/0.200=5. The pitch would be 5 threads per inch. 5 revolutions or turns would be required to advance the thread 1 inch axially.

The term “wedge threads” refers to a pin member equipped with dovetail shaped external threads whose pin thread tooth width increases in one axial direction along the pin member, while the box member is equipped with dovetail shaped internal threads whose box thread tooth width increases in the other axial direction. The mating set of helical screw threads provide a wedge like engagement of opposing pin and box flanks that limit the extent of relative rotation between the box and pin members. The rate at which the pin thread tooth or box thread tooth widens depends on the difference between the stab flank and load flank lead of the thread form.

The term “diametric interference” or “interference” describes an interference fit between the sealing surfaces of the seal or between surfaces of the thread form. Interference may be engineered to induce compressive stress around the cylinders that are higher than gas and fluid pressures within the tubular. The diameter of the sealing surface on the pin member can be designed larger than the sealing surface of the box member. The pressure resistance of the seal is controlled by the amount of interference.

The term “hoop stress” or “circumferential stress” is the force exerted circumferentially (perpendicular to the axis and the radius of the object) in both directions on every particle in the cylinder wall. An example of destructive hoop stress would be a burst pipe from high internal pressure. Along with axial stress and radial stress, hoop stress is a component of the stress tensor in cylindrical coordinates.

The term “curvilinear seal surface” in terms of the profile geometry herein refers to the seal surfaces being constructed of curves with respect to the central axis of the tubular. The curves may be composed of arcs and thus diverge from the central axis of the tubular at a nonconstant rate in contrast to a constant convergence of a frustoconical seal surface. The purpose of the curves is to slide over the frustoconical seal surface with high contact forces without galling or destructive deformation.

As used herein, the term “mill end” can refer to the side of a box member threaded coupling and a mill end pin member of a pipe joined together by the manufacturer at the mill. The pipe and threaded couplings are typically sold and transferred as a single unitized piece. After assembly the pipe or tubular can have one end that has male screw threads known as a “field end” pin member and another end with female screw threads known as a coupling field end.

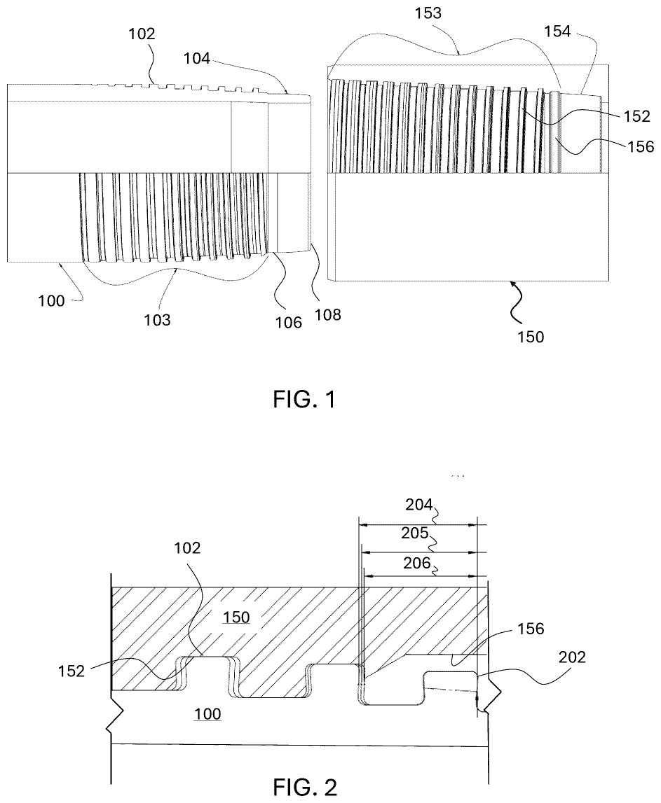

FIG. 1 depicts a pin member 100 aligned for insertion into a box member 150. The pin member 100 includes pin threads 102 disposed along a pin thread length 103 on an outer surface of the pin member 100. In some embodiments, the pin thread length 103 extends between 4.00 to 4.250 inches along the pin member 100. A separation area 106 may be disposed along the outer surface of the pin member 100 and lacks the pin threads 102 to space the pin threads 102 from a curvilinear seal surface 104, which may be formed on the outer surface of the pin member 100 at, or proximate, a terminal end 108 of the pin member 100. The separation area 106 may define a cylindrical or straight tapered outer diameter that is between the pin threads 102 and the curvilinear seal surface 104 and is further from the terminal end 108 of the pin member 100 than the curvilinear seal surface 104.

The box member 150 includes box threads 152 formed along an interior surface of the box member 150 as defined by a box thread length 153, which may substantially correspond to the pin thread length 103. According to some embodiments, the box member 150 further includes a relief groove 156 in the interior surface disposed between the box threads 152 and a frustoconical seal surface 154 in the interior surface of the box member 150. The pin and box threads 102, 152 shapes mate together to form a threaded connection region and limit axial advancement of the pin member 100 within the box member 150 to not pass beyond a connected position, which is preset based on desired interference of the curvilinear seal surface 104 with the frustoconical seal surface 154. The curvilinear seal surface 104 of the pin member 100 shares a same longitudinal central axis with the frustoconical seal surface 154 of the box member 150 such that a seal forms by interference at an interface between the curvilinear seal surface 104 and the frustoconical seal surface 154 in the connected position. In the connected position, the separation area 106 of the pin member 100 lacks contact with the box member 150 interior surface due to the separation area 106 having a relative smaller outer diameter than inner diameter of a corresponding section of the box member 150.

FIG. 2 shows part of the pin and box members 100, 150 in the connected position with a leading portion 202 of the pin threads 102 disposed in the relief groove 156 of the box member 150. The relief groove 156 in the interior surface of the box member 150 has a larger inside diameter relative to both an outer diameter of the leading portion 202 for crests of the pin threads 102 and an inner diameter for roots of the box threads 152 adjacent the relief groove 156 such that the leading portion 202 of the pin threads 102 thereby lack contact with the box member 150 in the connected position. The lack of contact between the leading portion 202 of the pin threads 102 and the box member 150 at the relief groove 156 avoids stress being applied to the leading portion 202 of the pin threads 102 caused by the interference fit of the curvilinear seal surface 104 with the frustoconical seal surface 154 once in the connected position.

For some embodiments, the separation area 106 of the pin member 100 may distance where contact occurs between the frustoconical seal surface 154 and the curvilinear seal surface 104 from the pin threads 102 along length of the pin member 100 more than 0.4 and less than 0.6 inches. Such separation further facilitates mitigation of radial stress on the pin threads 102 caused by the interference fit of the curvilinear seal surface 104 with the frustoconical seal surface 154 once in the connected position. Avoiding damage to the pin and box threads 102, 152 due to the separation area 106 and/or the relief groove 156 means couplings may be reused multiple times extending useful life of the couplings.

The curvilinear seal surface 104 being located between the terminal end 108 of the pin member 100 and the pin threads 102 provides sealing of tubular contents from contacting the threaded connection region. Furthermore, the curvilinear seal surface 104 and the frustoconical seal surface 154 contact provides non-linear point to point contact, which is effective for sealing tubulars that may be bent or flexed. Limited seal surface contact stresses resulting between the curvilinear seal surface 104 and frustoconical seal surface 154 also facilitate repeated assembly and disassembly of the threaded connection region for reuse.

The pin and box threads 102, 152 may provide the only limit for axial advancement of the pin member 100 within the box member 150 to the connected position. The interference fit of the curvilinear seal surface 104 with the frustoconical seal surface 154 thus occurs without the terminal end 108 of the pin member 100 otherwise bottoming out in the box member 150 if the curvilinear seal surface 104 is not at the terminal end 108 and without causing contact of any mating shoulders between the pin and box members 100, 150 (i.e., without contact of axial limiting mating profiles between the pin and box members 100, 150 outside of the threaded connection region between the pin and box threads 102, 152). The frustoconical seal surface 154 design supports using the pin and box threads 102, 152 alone to limit axial advancement of the pin member 100 to the connected position.

Referring to FIG. 1 and FIG. 2, wedge threads may provide the pin and box threads 102, 152 with tapers of the pin and box threads 102, 152 that may match. In some embodiments, the box threads 152 taper between 0.08 inch/inch and 0.1 inch/inch while the frustoconical seal surface 154 tapers between 0.09 inch/inch and 0.142 inch/inch. The frustoconical seal surface 154 may taper between 10% and 55%, or less than 55%, more than the box threads 152 taper.

The relatively small difference between the seal taper and the thread taper provides desired sealing while limiting radial stresses on the pin and box threads 102, 152. The taper shallowness of the frustoconical seal surface 154 facilitates achieving desired interference without excessive interference buildup between the curvilinear seal surface 104 and the frustoconical seal surface 154. Axial variation of the connected position inherently occurs due to machining tolerances. The shallowness of taper for the frustoconical seal surface 154 can also help create the seal interference necessary for proper sealing even with the axial variation caused by the tolerances.

In some embodiments, the pin and box threads 102, 152 height extends between 0.07 to 0.072 inches. The pin and box threads 102, 152 define a load flank lead 204, a mid-lead 205 and a stab flank lead 206, as depicted in FIG. 2. According to some embodiments, the load flank lead 204 is 0.28 inches with the stab flank lead 206 being 0.27 inches, or otherwise sized to provide a difference between the load flank lead 204 and the stab flank lead 206 that is about, or at, 0.01 inches.

The thread crests and thread roots of the pin and box threads 102, 152 come into contact before any contact of the thread flanks forcing the tubular into a round rather than out of round shape. In some embodiments as shown in FIG. 4, the pin thread crests of the pin member 100 may contact the box thread roots of the box member 150 at radial contact areas 415 while maintaining a gap of 0.002 inches or less (e.g., between 0.0001 to 0.002 inches) at radial gap areas 425 between the box thread crests and the pin thread roots. Further engagement of the dovetail flanks of the pin and box threads 102, 152 lock the radial position and desired interference of the seal into place. The thread height and pin and box thread length 103, 153 provide a desired amount of torque required to move the curvilinear seal surface 104 and the frustoconical seal surface 154 together. The pin and box threads 102, 152 also avoid radial stress or galling and allow the increasing hoop stress caused by the tapered threads to be mitigated.

For illustration purposes, FIG. 4 depicts separation at the radial gap areas 425 exaggerated between the box crest and the pin root. Also, threads of the pin and box members 100, 150 are shown not fully mated on the stab flank for depiction purposes. The radial gap areas 425 may alleviate adverse thread compound pressures from building up between the threads by allowing thread compound to flow under when the flanks are fully tightened to provide torque and stabilize axial position.

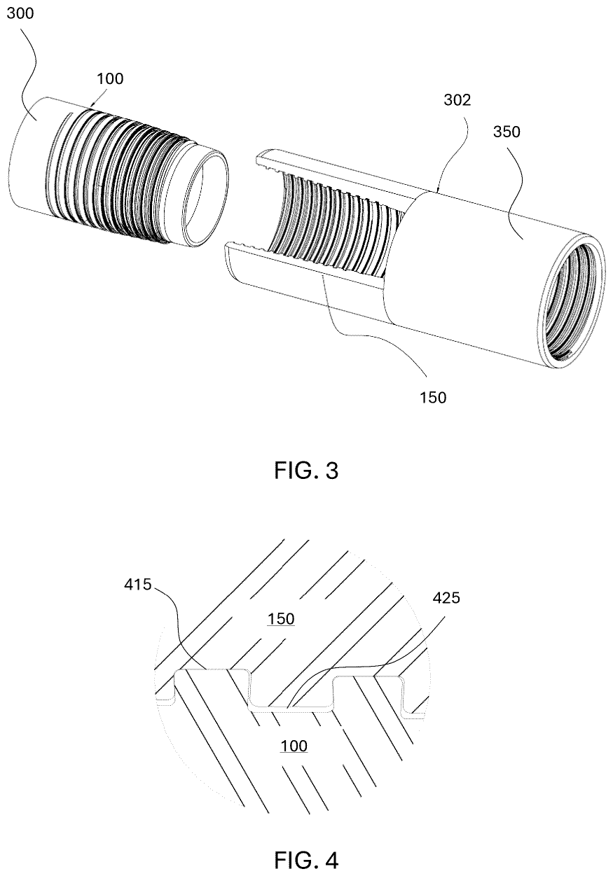

FIG. 3 illustrates the pin member 100 of a tubular 300 and the box member 150 shown as part of a dual box end coupler 302, as may be used by a manufacturer at a mill. The pin member 100 may be on the first end of the tubular 300 that has an analogous pin member on the second end of the tubular 300. The dual box end coupler 302 may include the box member 150 and an analogous additional box 350 opposite facing and directly abutting the box member 150 without intervening tubing. Once the pin member 100 on the first end of the tubular 300 is connected to the box member 150 of the dual box end coupler 302, the tubular 300 then can be connected to other like tubulars given male and female ends defined by the pin member on the second of the tubular 300 and the analogous additional box 350 extending from the first end of the tubular 300.

The present embodiments can improve sealing by controlling the seal diametric interference due to various coupling aspects as disclosed herein including seal geometry in relation to the tapers between the seal and thread and the thread position. The coupling of embodiments disclosed thus helps prevent liquid leaking, thereby preventing toxic spills. Further, the present embodiments can stabilize the threads under cyclic axial loads of tension and compression, as well as under bending loads, by stab flank and load flank contact, which restricts the movement of the engaged threads.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A coupling, comprising:
a box member with an interior surface that includes:
box threads;
a frustoconical seal surface; and
a relief groove disposed between the box threads and the frustoconical seal surface; and
a pin member having a mating shape to be inserted into the box member, wherein an outer surface of the pin member includes:
pin threads shaped to mate with the box threads to form a threaded connection region and limit axial advancement of the pin member within the box member to a connected position, which connected position disposes a leading portion of the pin threads in the relief groove of the box member such that the leading portion of the pin threads thereby lack contact with the box member; and
a curvilinear seal surface sharing a same longitudinal central axis with the frustoconical seal surface of the box member such that a seal forms at an interface between the curvilinear seal surface and the frustoconical seal surface in the connected position.

2. The coupling of claim 1, wherein the curvilinear seal surface is located between a terminal end of the pin member and the pin threads.

3. The coupling of claim 1, wherein the box threads and the pin threads are wedge threads.

4. The coupling of claim 1, wherein tapers of the box threads and the pin threads match.

5. The coupling of claim 1, wherein the box threads taper between 0.08 inch/inch and 0.1 inch/inch and the frustoconical seal surface tapers between 0.09 inch/inch and 0.142 inch/inch.

6. The coupling of claim 1, wherein contact of the frustoconical seal surface and the curvilinear seal surface in the connected position is separated along length of the pin member more than 0.4 and less than 0.6 inches from the pin threads.

7. The coupling of claim 1, wherein height of the pin threads and box threads is 0.07 to 0.072 inches.

8. The coupling of claim 1, wherein the pin threads extend along the pin member a length of 4.0 to 4.25 inches.

9. The coupling of claim 1, wherein load flank lead is 0.28 inches and stab flank lead is 0.27 inches with the box threads and the pin threads being wedge threads.

10. The coupling of claim 1, wherein the curvilinear seal surface begins at a terminal end of the pin member.

11. The coupling of claim 1, wherein interference of the curvilinear seal surface with the frustoconical seal surface occurs without contact of axial limiting mating profiles between the pin and box members outside of the threaded connection region.

12. The coupling of claim 1, wherein the relief groove of the box member defines a larger inside diameter relative to both an outer diameter of the leading portion for crests of the pin threads and an inner diameter for roots of the box threads adjacent the relief groove.

13. The coupling of claim 1, wherein the outer surface of the pin member includes a separation area that lacks the pin threads and is disposed between the pin threads and the curvilinear seal surface such that in the connected position contact of the frustoconical seal surface with the curvilinear seal surface is separated along length of the pin member more than 0.4 and less than 0.6 inches from the pin threads.

14. The coupling of claim 1, wherein the outer surface of the pin member includes a separation area that lacks the pin threads, is tapered and is disposed between the pin threads and the curvilinear seal surface.

15. The coupling of claim 1, wherein the box member is part of a dual box coupler having an analogous additional box opposite facing and directly abutting the box member.

16. The coupling of claim 1, wherein pin thread crests of the pin threads contact box thread roots of the box threads while a gap is maintained between box thread crests of the box threads and pin thread roots of the pin threads when in the connected position.

17. A coupling, comprising:
a box member with an interior surface that includes:
box threads in a wedge thread shape and taper between 0.08 inch/inch and 0.1 inch/inch;
a frustoconical seal surface with taper between 0.09 inch/inch and 0.142 inch/inch; and
a relief groove disposed between the box threads and the frustoconical seal surface, wherein the relief groove defines an inner diameter of the box member greater than at roots of the box threads adjacent the relief groove; and
a pin member having a mating shape to be inserted into the box member, wherein an outer surface of the pin member includes:
pin threads with taper between 0.08 inch/inch and 0.1 inch/inch and shaped to mate with the box threads to form a threaded connection region and limit axial advancement of the pin member within the box member to a connected position, which connected position disposes a leading portion of the pin threads in the relief groove of the box member such that the leading portion of the pin threads thereby lack contact with the box member, wherein the pin threads extend along the pin member a length of 4.0 to 4.25 inches, have a height of 0.07 to 0.072 inches and provide difference between the load flank lead and stab flank lead that is 0.1 inches;
a curvilinear seal surface sharing a same longitudinal central axis with the frustoconical seal surface of the box member such that a seal forms at an interface between the curvilinear seal surface and the frustoconical seal surface in the connected position; and
a separation area that lacks the pin threads and is disposed between the pin threads and the curvilinear seal surface such that contact in the connected position of the frustoconical seal surface with the curvilinear seal surface is separated along length of the pin member more than 0.4 and less than 0.6 inches from the pin threads.

18. The coupling of claim 17, wherein the separation area is tapered.

19. The coupling of claim 17, wherein interference of the curvilinear seal surface with the frustoconical seal surface occurs in the connected position without contact of axial limiting mating profiles between the pin and box members outside of the threaded connection region.

20. The coupling of claim 17, wherein the box member is part of a dual box coupler having an analogous additional box opposite facing and directly abutting the box member.
